(19) United States
(12) Patent Application Publication
(10) Pub. No.: US 2018/0063366 A1
(43) Pub. Date: Mar. 1, 2018

(54) IMAGE OUTPUT APPARATUS, HISTORY DISPLAY APPARATUS, HISTORY DISPLAY METHOD, AND NON-TRANSITORY COMPUTER READABLE MEDIUM

(71) Applicant: FUJI XEROX CO., LTD., Tokyo (JP)

(72) Inventors: Yasuhiro MORI, Kanagawa (JP); Nobuhide KAWABATA, Kanagawa (JP)

(73) Assignee: FUJI XEROX CO., LTD., Tokyo (JP)

(21) Appl. No.: 15/439,291

(22) Filed: Feb. 22, 2017

(30) Foreign Application Priority Data
Aug. 30, 2016 (JP) 2016-167425

(51) Int. Cl. H04N 1/32; H04N 1/00

(52) U.S. Cl. CPC H04N 1/32122; H04N 1/00411; H04N 1/32694; H04N 2201/3223; H04N 2201/0094; H04N 2201/3202; H04N 2201/3215; H04N 1/00424

(57) ABSTRACT

An image output apparatus includes an image printer, a history memory, and a history display. The image printer prints an image based on image data in accordance with adjunct data for each job including a set of the image data expressing one set of images and the adjunct data necessary for image printing based on, the image data. The history memory records and stores printing history of printing performed, for each job in the image printer. The printing history includes recording of whether or not any one of predetermined types of errors has occurred and the type of error when occurred. The history display displays the history such that an icon corresponding to an error occurred in a job is displayed in correspondence with the job. The icon is one of icons respectively corresponding to groups obtained by classifying the predetermined types of errors into multiple groups.

### CROSS-REFERENCE TO RELATED APPLICATIONS

This application is based on and claims priority under 35 USC 119 from Japanese Patent Application No. 2016-167425 filed Aug. 30, 2016.

### BACKGROUND

### Technical Field

The present invention relates to image output apparatuses, history display apparatuses, history display methods, and non-transitory computer readable media.

### SUMMARY

According to an aspect of the invention, there is provided an image output apparatus including an image printer, a history memory, and a history display. The image printer prints an image based on image data in accordance with adjunct data for each job including a set of the image data expressing one set of images and the adjunct data necessary for image printing based on the image data. The history memory records and stores printing history of printing performed for each job in the image printer. The printing history includes recording of whether or not any one of multiple predetermined types of errors has occurred and the type of error when an error has occurred. The history display displays the history stored in the history memory such that an icon corresponding to an error that has occurred in a job is displayed in correspondence with the job in which the error has occurred. The icon is one of icons respectively corresponding to groups obtained by classifying the multiple predetermined types of errors into multiple groups.

### BRIEF DESCRIPTION OF THE DRAWINGS

Exemplary embodiments of the present invention will be described in detail based on the following figures, wherein:

FIG. 1 schematically illustrates the overall configuration of a printing system;

FIG. 2 illustrates the configuration of software according to an exemplary embodiment;

FIG. 3 illustrates a history information file in a storage device;

FIG. 4 illustrates the contents of each event ID expressing an event;

FIG. 5 illustrates the contents of keys and values expressing event parameters;

FIG. 6 illustrates a history display screen displayed on a display screen of a display-input device;

FIG. 7 illustrates a first example of a pop-up screen showing the details of an error;

FIG. 8 illustrates a second example of a pop-up screen showing the details of an error;

FIG. 9 illustrates a third example of a pop-up screen showing the details of an error;

FIG. 10 is a flowchart of a printing process routine; and

FIG. 11 illustrates a flowchart of a history display process routine.

### DETAILED DESCRIPTION

An exemplary embodiment of the present invention will be described below.

The exemplary embodiment to be described below entirely deals with images in the form of data except for images printed on paper. In the following description, an image in the form of data may sometimes be not clearly indicated as an image in the form of data, as in, for example, “image data” and may be simply expressed as “image”. The same applies to other terms that are in the category of images, such as documents.

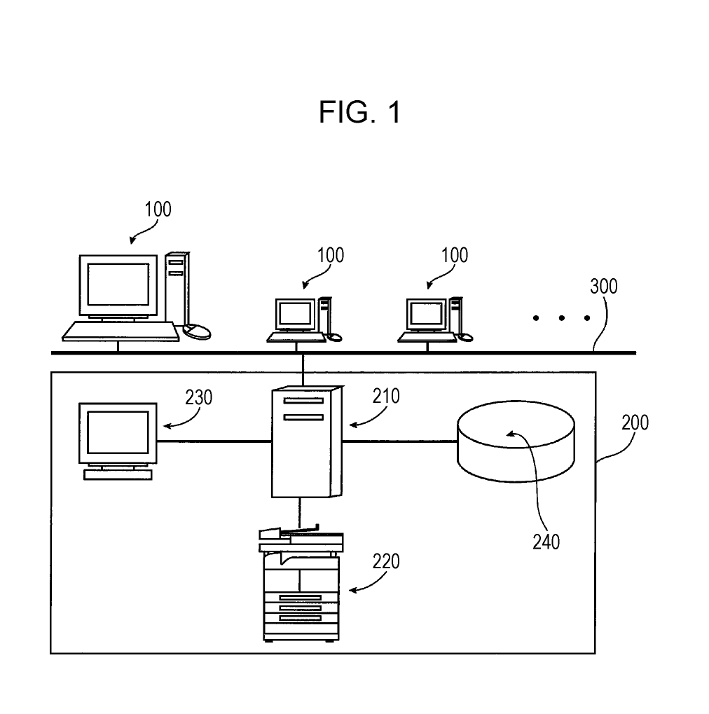

FIG. 1 schematically illustrates the overall configuration of a printing system. The printing system shown in FIG. 1 includes an image output apparatus, a history display apparatus, and a history display program according to exemplary embodiments of the present invention.

A printing system 1 shown in FIG. 1 includes multiple client personal computers (PCs) 100 and an image output apparatus 00, which are connected to one another via a network 300.

In each client PC 100, a user operates it to perform an image creating-editing process.

The image output apparatus 200 is constituted of a server 210, a multifunction device 220, a display-input device 230, and a storage device 240.

The server 210 receives a print job from one of the client PCs 100 via the network 300 and causes the multifunction device 220 to execute printing based on the job. In this case, the term “job” includes a set of image data expressing one set of images and adjunct data necessary for image printing based on the image data.

The multifunction device 220 performs image printing on paper in accordance with a command from the server 210. In addition to having a printing function for performing image printing on paper based on a job, the multifunction device 220 has multiple functions, such as a scanning function for acquiring image data by reading an image from a document having the image recorded on paper and for transmitting the image data to a designated client PC 100 and a copying function for reading an image from a document and printing the image onto paper based on the acquired image data. The multifunction device 220 may also have an additional mechanism for rearranging the order of printed sheets or stapling them together.

The display-input device 230 includes, for example, a touch screen display screen and performs image display as well as receiving an operation input by a user.

The storage device 240 temporarily stores a job in a printing queue. The storage device 240 also stores the printing history of each job performed in the multifunction device 220. The printing history will be described in detail later.

The multifunction device 220, the display-input device 230, and the storage device 240 constituting the image output apparatus 200 correspond tea examples of an image printer, a history display, and a history memory according to exemplary embodiments of the present invention. The server 210 functions as a controller that controls the multifunction device 220, the display-input device 230, and the storage device 240.

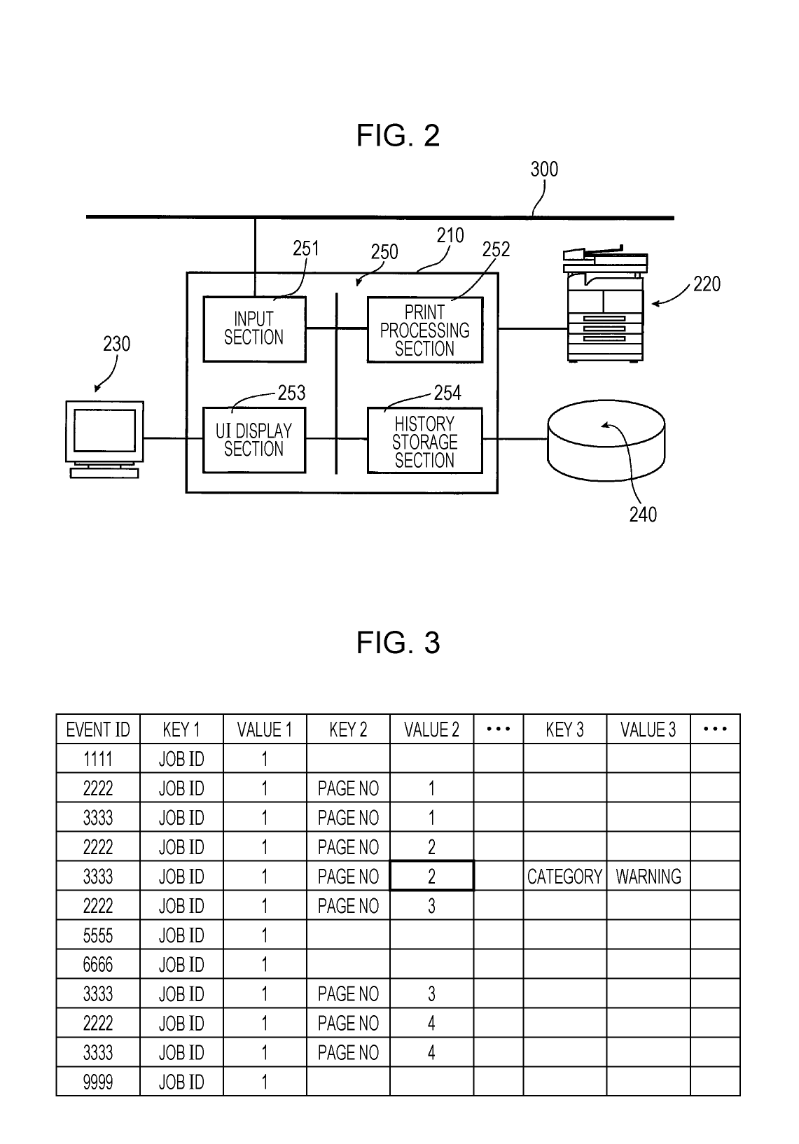

FIG. 2 illustrates the configuration of software according to this exemplary embodiment. This software will be referred to as a printing program 250. The printing program 250 includes an example of a history display program according to an exemplary embodiment of the present invention and is executed by the server 210.

The printing program 250 has program components, namely, an input section 251, a print processing section 252, a user-interface (UI) display section 253, and a history storage section 254.

The input section 251 receives a job via the network 300.

The print processing section 252 converts the image based on the job received by the input section 251 into data in a format printable by the multifunction device 220, transmits the data to the multifunction device 220, and causes the multifunction device 220 to print the image based on the data. Furthermore, the print processing section 252 constantly monitors the printing status of the multifunction device 220 and collects printing history information thereof.

The UI display section 253 has a function of causing the display-input device 230 to display an image and also loading information input to the display-input device 230.

The history storage section 254 acquires the printing history information of the multifunction device 220 collected by the print processing section 252 and stores the printing history information into the storage device 240. Furthermore, when a request is received from the UI display section 253, the history storage section 254 reads the printing history information stored in the storage device 240 and transmits the printing history information to the display section 253. Upon receiving the history information, the UI display section 253 causes the display screen of the display-input device 230 to display an image showing the history based on the history information.

The combination of the server 210, the display-input device 230, and the storage device 240 corresponds to an example of an information processing apparatus according to an exemplary embodiment of the present invention. In the printing program 250, a section that collects, stores, and displays the printing history of the multifunction device 220 corresponds to an example of a history display program according to an exemplary embodiment of the present invention.

The general configuration for storing and displaying the printing history of the multifunction device 220 will be described below, followed by a specific example.

In this exemplary embodiment, the printing history information of each job in the multifunction device 220 is stored in the storage device 240. For each job, this history information contains information indicating whether or not an error has occurred and the type of error when an error occurs. More specifically, with regard to a job in which an error has occurred, the history information contains information indicating whether the error that has occurred is a warning as an error not involving stoppage of the printing process or is a fault as an error involving stoppage of the printing process. Furthermore, in this exemplary embodiment, the history information contains information indicating whether the fault as an error involving stoppage of the printing process is a fault recoverable by user treatment or a fault unrecoverable by user treatment. A warning as an error not involving stoppage of the printing process refers to an error for attracting user's attention when there is a possibility that the printing process to be performed may be unsatisfactory to the user, such as in a case where there is no designated font in the job and the image data is converted into a data format after being replaced with another font when the print processing section 252 performs the data-format conversion process on the image data or in a case where a calibration process, which is a maintenance process for adjusting the image quality of the print image, has not been performed for a predetermined period or longer. A fault recoverable by user treatment includes, for example, a paper shortage, an ink (toner) shortage, or a paper jam. A fault unrecoverable by user treatment includes, for example, a failure of an electronic circuit or a rotational detect in a motor.

The history stored in the storage device 240 includes image data expressing an image of a page corresponding to an error occurrence page in a in which an error has occurred. The “page corresponding to an error occurrence page” refers to a page for informing the user of which page an error has occurred in during the printing process. For example, in a case where the printing process is successful up to the third page but is unsuccessful when printing an image of the fourth page due to a paper shortage, the image of the final third page for which the printing is already performed s the “page corresponding to an error occurrence page”. The “image data of a page corresponding to an error occurrence page” may be image data expressing a full-size image of the page, or may be image data expressing a thumbnail image of the page for saving the storage space in the storage device 240 or due to limited display space of the display screen in the display-input device 230.

The history information stored in the storage device 240 further contains information about the print start time, the error occurrence time, the error resolved time, and the print end time of each job.

When displaying the history on the display screen of the display-input device 230, the history stored in the storage device 240 is displayed such that an icon corresponding to an error that has occurred in a job is displayed in correspondence with that job in which the error has occurred. Specifically, the types of errors are classified into multiple groups, and the displayed icon is one of icons respectively corresponding to the multiple groups. In other words, in this exemplary embodiment, of icons respectively corresponding to multiple classified groups including information indicating whether an error is a warning as an error not involving stoppage of the printing process or is a fault as an error involving stoppage of the printing process, the history stored in the storage device 240 is displayed such that an icon corresponding to an error that has occurred in a certain job is displayed in correspondence with that job. Furthermore, in this exemplary embodiment, with regard to a job in which a fault involving stoppage of the printing process has occurred, the types of faults are classified into multiple groups including information indicating whether the fault is a fault recoverable by user treatment or a fault unrecoverable by user treatment, and of icons respectively corresponding to the multiple groups, an icon corresponding to the fault that has occurred in that job is displayed in correspondence with that job. Therefore, in this exemplary embodiment, an indication of whether or not an error or a fault has occurred in the printing process is displayed to the user in an easily understandable manner, as compared with a case where a job and an icon according to the type of error or fault are not displayed in correspondence with each other. Moreover, the user may quickly and, appropriately move on to subsequent treatment, as compared with a case where it is difficult to recognize whether an error is a warning not involving stoppage of the printing process or a fault involving stoppage of the printing process based on an icon or a case where it is difficult to recognize whether a fault is recoverable or unrecoverable based on an icon.

Furthermore, when displaying the history on the display screen of the display-input device 230, with regard to a job in which an error (warning or fault) has occurred, an image (e.g., thumbnail image) based on image data expressing an image of a page corresponding to an error occurrence page is displayed in correspondence with that job. Therefore, in this exemplary embodiment, the user may readily specify the error occurrence page in the job in which the error has occurred, as compared with a case where an image (e.g., thumbnail image) based on image data expressing an image of a page corresponding to an error occurrence page is not displayed.

Furthermore, when displaying the history on the display screen of the splay-input device 230, a time indicator image indicating the print start time, the error occurrence time, the error resolved time, and the print end time is displayed for each job. Therefore, in this exemplary embodiment, the user may readily ascertain the printing history, as compared with a case where the time image is not displayed.

Furthermore, when displaying the history on the display screen of the display-input device 230, indicator display and detailed display are performed. Specifically, the indicator display includes displaying an indicator that specifies a job stored as history in the storage device 240 and an indicator that indicates whether or not an error has occurred in that job. The detailed display includes displaying the details of the error that has occurred in the job stored in the storage device 240 are performed.

FIG. 3 illustrates a history information file in the storage device 240.

The history information is created by writing information into a table constituted of events expressed by “event IDs” and event parameters expressed by pairs of keys and values every time an event actually occurs. FIG. 3 illustrates an example in which an error at a warning level and a paper shortage, which is an error at a fault level, have occurred.

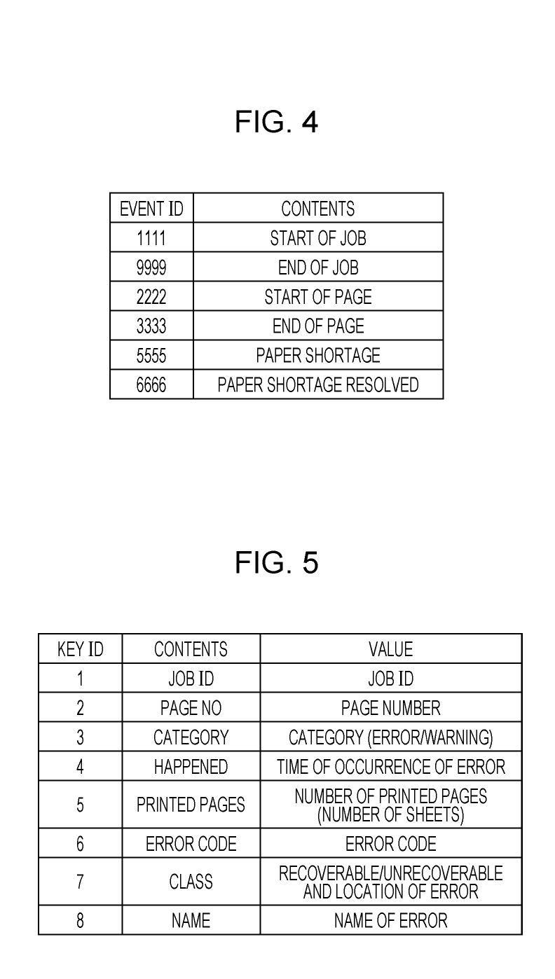

FIG. 4 illustrates the contents of each event ID expressing an event.

The start of a job is expressed as event ID=1111, and the end of the job is expressed as event ID=9999. The start of a page (i.e., the start of one page worth of printing) is expressed as event ID=2222, and the end of the page (i.e., the end of one page worth of printing) is expressed as event ID=3333. A paper shortage is expressed as event ID=5555, and paper shortage resolved is expressed as event ID=6666. Although there are many events other than the events (event IDs) shown in FIG. 4, descriptions thereof will be omitted here to prevent complexity.

FIG. 5 illustrates the contents of keys and values expressing event parameters.

Although only key 1, key 2, and key 3 are shown as key IDs in FIG. 3 and other key IDs are not shown, the key IDs in this exemplary embodiment include eight types from key 1 to key 8.

First, key ID=key 1 indicates a job ID, and the value thereof is a numerical value expressing that job ID.

Furthermore, key ID=key 2 indicates a page number, and the value thereof indicates that page number.

Moreover, key ID=key 3 indicates the category of an error that has occurred (error/warning), and the value thereof is a numerical value expressing that category (error/warning).

Furthermore, key ID=key 4 indicates the time at which that event has occurred, and the value thereof is a numerical value expressing the time.

Moreover, key ID=key 5 indicates the number of printed pages, and the value thereof is a numerical value expressing that number of printed pages.

Furthermore, key ID=key 6 indicates an error code, and the value thereof is that error code. In this case, error codes are given to all errors including a warning.

Moreover, key ID=key 7 indicates whether the error is recoverable or unrecoverable as well as the location where the error has occurred, and the value thereof is a numerical value for specifying whether the error is recoverable or unrecoverable as well as for specifying the location where the error has occurred.

Furthermore, key ID=key 8 indicates the name of the error, and the value thereof is the name of that error.

As an alternative to this example in which there are eight types of key from key 1 to key 8, an arbitrary number of key IDs appropriate for that system may be set. For example, a key ID for the number of print copies may be added as key 9, and a method of specifying which page of which copy may be employed when specifying a print page.

Referring back to FIG. 3, the description will continue.

With regard to the history information file shown in FIG. 3, when performing the printing process for the job of job ID=1, the first page is printed successfully without any errors. Then, an error at the warning level occurs during the printing of the second page. Subsequently, a paper Shortage (event ID=5555) occurs at the third page. After the paper shortage is resolved (event ID=5666), the third and fourth pages are successfully printed, so that the printing process for this job of job ID=1 is completed.

With regard to the paper shortage at the third page, the history storage section 254 stores the thumbnail image of the final page (i.e., the second page in this case), for which the printing is already performed, in correspondence with the paper shortage at the third page, and the stored thumbnail image is displayed in a display process to be described later.

With regard to the warning of the second page, the thumbnail image of the leading page in which the fault of that warning has occurred (i.e., the second page similar to the above-described case of the paper shortage) is stored in correspondence to the warning of the second page, and the stored thumbnail image is displayed in a display process to be described later.

Although the above description relates to an example where the printing history is stored in the form of a table for each event (event ID) shown in FIG. 3, the printing history may be written in a natural language, as in explanatory text, to the user, and when displaying the printing history, necessary information may be extracted and displayed by analyzing the printing history written in the natural language.

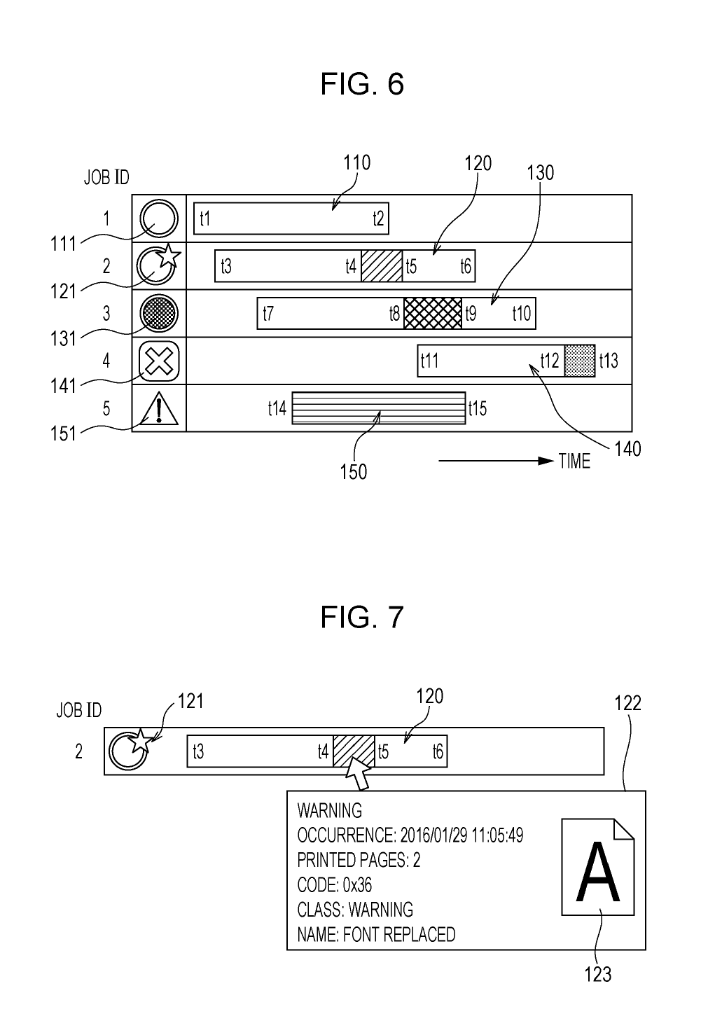

FIG. 6 illustrates a history display screen displayed on the display screen of the display-input device 230. This history display screen corresponds to an example of “indicator display” according to en exemplary embodiment of the present invention.

FIG. 6 illustrates five lobs, namely, job IDs 1, 2, 3, 4, and 5. The jobs are expressed by icons 111, 121, 131, 141, and 151 and timelines 110, 120, 130, 140, and 150, which are horizontally-extending bar graphs, respectively corresponding to the job IDs 1, 2, 3, 4, and 5. The horizontal axis of the timelines 110, 120, 130, 140, and 150 is a time axis. Each of the timelines 110, 120, 130, 140, and 150 corresponds to an example of a time indicator image according to an exemplary embodiment of the present invention.

Although actual printing is performed sequentially from job to job, FIG. 6 shows that printing processes of multiple jobs are performed concurrently for the sake of convenience.

The icon 111 corresponding to the job of job ID=1 expresses that the printing of that job has been successfully performed for all pages. The printing process for this job of job ID=1 starts at a time t1 and ends at a time t2.

The icon 121 corresponding to the job of job ID=2 expresses an error at the warning level. The printing process for this job of job ID=2 starts at a time t3, an error at the warning level occurs at a time t4, the printing process resumes immediately since the error is at the warning level, the error at the warning level is resolved at a time t5, and the printing process ends at a time t6.

A region between the time t4 and the time t5 in the timeline 120 corresponding to the job of job ID=2 is expressed with a color (diagonal hatching in FIG. 6) corresponding to the error at the warning level.

The icon 131 corresponding to the job of job ID=3 corresponds to a fault (error) involving an interruption in the printing process and recoverable by user treatment, such as a paper shortage. The printing process for this job of job ID=3 starts at a time t7 and is interrupted at a time t8. Then, the printing process resumes at a time t9 and ends at a time t10. A region from the time t8 to the time t9 in the timeline 130 is expressed with a color (meshing in FIG. 6) corresponding to the interruption in the printing process. The color corresponding to the interruption in the printing process in this timeline 130 is also a color corresponding to a recoverable fault.

Although this timeline 130 is displayed upon completion of the printing process after resuming the printing process, if the timeline 130 is displayed while the printing process is Still interrupted, the timeline 130 only displays up to the interrupted part prior to the time t9.

The icon 141 corresponding to job ID=4 corresponds to a fault (error) involving an interruption in the printing process and unrecoverable by user treatment, such as a failure of an electronic circuit. The printing process for this job of job ID=4 starts at a time t11 and is interrupted at a time t12. A time t13 is the time at which the power of the multifunction device 220 is turned off and is set for convenience. A region between the time t12 and the time t13 in the timeline 140 is expressed with a color (shading in FIG. 6) corresponding to the unrecoverable fault.

The icon 151 corresponding to job ID=5 corresponds to stoppage of the printing process in a job with no occurrence of an error. In a job in which an error has occurred, an icon according to the type of the error occurred in that job is set in correspondence therewith even if the printing process for the job is stopped in mid-course. The printing process for the job of job ID=5 starts at a time t14 and is stopped at a time t15. The timeline 150 is expressed with a color (horizontal lines in FIG. 6) corresponding to the stoppage of the printing process. A timeline corresponding to a case where there is an error and the printing process is interrupted mid-course is a timeline according to that error. For example, when a paper shortage occurs and the printing process is stopped, the timeline is similar to the timeline 130. However, since the printing process is stopped, the timeline ends at the time at which the printing process is stopped, and does not extend to a subsequent time.

FIG. 7 illustrates a first example of a pop-up screen showing the details of an error.

A pop-up screen 122 shown in FIG. 7 is displayed when a cursor is placed on the region between the time t4 and the time t5 (i.e., the region expressed with the warning color) in the timeline 120 of the job of job ID=2 shown in FIG. 6.

This pop-up screen 122 indicates that the error is at the warning level and displays the detailed contents of the error and a thumbnail image 123 of the first page after the occurrence of the error.

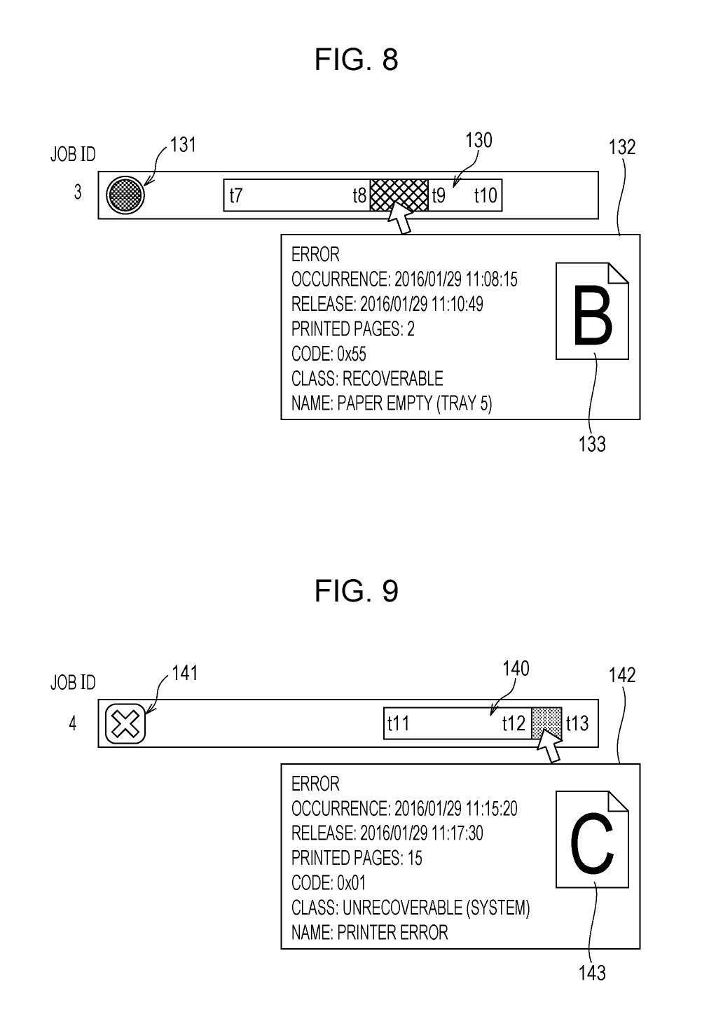

FIG. 8 illustrates a second example of a pop-up screen showing the details of an error.

A pop-up screen 132 shown in FIG. 8 is displayed when a cursor is placed on the region, which is expressed with the color corresponding to the recoverable interruption of the printing process, between the time t8 and the time t9 in the timeline 130 of the job of job ID=3 shown in FIG. 6.

This pop-up screen 132 indicates that the fault (error) is at the printing interruption level and displays the detailed contents of the fault, which includes a recoverable fault of a paper shortage in a tray 5, and a thumbnail image 133 of a page immediately before the occurrence of the fault.

FIG. 9 illustrates a third example of a pop-up screen showing the details of an error.

A pop-up screen 142 shown in FIG. 9 is displayed when a cursor is placed on the region, which is expressed with the color corresponding to the unrecoverable interruption of the printing process, between the time t12 and the time t13 in the timeline 140 of the job of job ID=4 shown in FIG. 6.

This pop-up screen 142 indicates that the fault (error) is at the printing interruption level and displays the detailed contents of the fault, which includes an unrecoverable system fault, and a thumbnail image 143 of a page immediately before the occurrence of the fault.

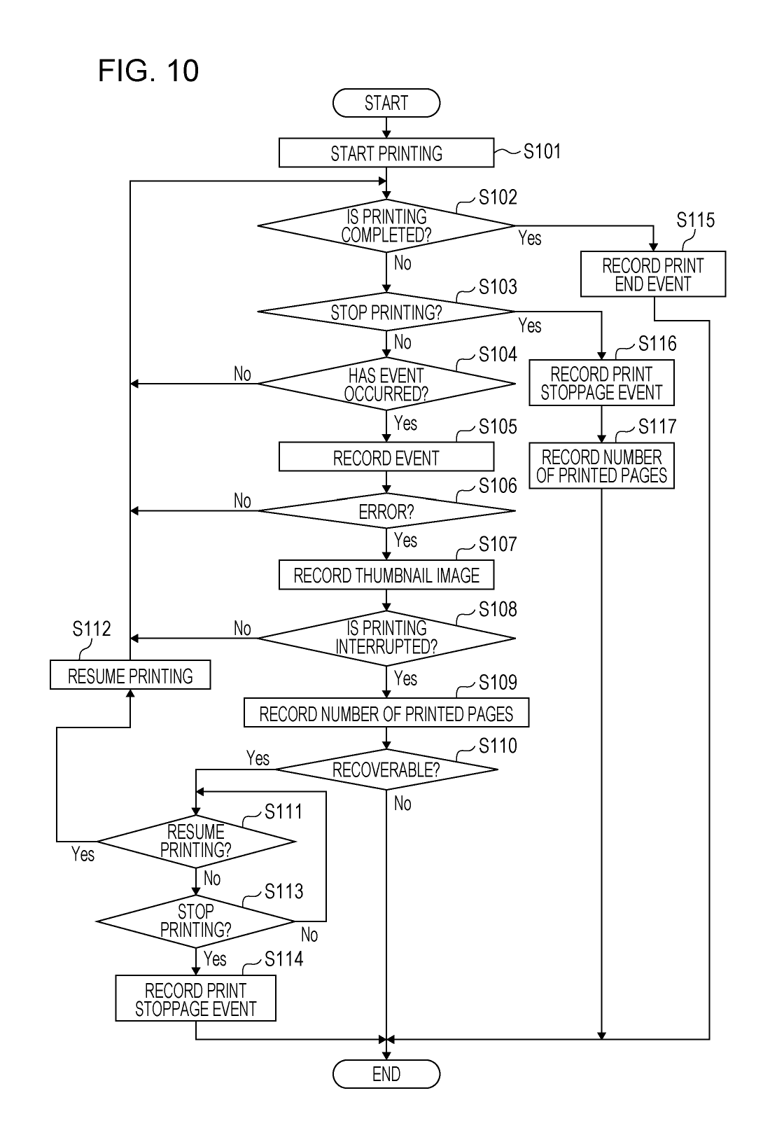

FIG. 10 is a flowchart of a printing process routine.

The printing process routine shown in FIG. 10 is executed by the server 210 (see FIG. 1) when the data-format conversion of image data to be printed is completed in the print processing section 252 shown in FIG. 2 or when the data-format conversion is completed and this job reaches its turn for the printing process in a case where the job is waiting for its turn due to the multifunction device 220 performing the printing process for another job.

When the printing process starts in step S101, the process from step S104 and onward is executed until the printing process for the job is completed in step S102 or the user makes a command for interrupting the printing process in step S103.

In this case, it is first determined in step S104 whether an event (see FIG. 4) has occurred. When an event occurs, the event is recorded as printing history (see FIG. 3) in step S105. The start of the printing process is also an event (event ID=1111), and the event of the start of the printing process is recorded when the printing process starts.

If it is determined in step S104 that an event has not occurred, the process returns to step S102.

When an event occurs and t event is recorded in step S105, it is subsequently determined in step S106 whether or not the event that has occurred this time is an event in which an “error” has occurred. If the event that has occurred this time is an event other than an event in which an error has occurred (e.g., the start of printing of a certain page (i.e., an event of event ID=2222) or the end of printing of a certain page (i.e., an event of event ID=3333)), the process returns to step S102.

In contrast, if the event that has occurred this time is an event in which an error has occurred, a thumbnail image of a page (i.e., the page immediately before the occurrence of the error or the first page after the occurrence of the error in accordance with the type of error) corresponding to the page in which the error has occurred is recorded in correspondence with the current event in step S107.

Then, it is determined in step S108 whether the error that has occurred this time is a fault (error) involving an interruption of the printing process or a warning. If the error that has occurred this time is an error at the warning level, the process returns to step S102.

If the error that has occurred this time is a fault (error) involving an interruption of the printing process, the number of printed pages is recorded in correspondence with the event of the error that has occurred this time in step S109.

Furthermore, it is determined in step S110 whether the error (fault) this time is a fault recoverable by user treatment or a fault unrecoverable by user treatment. In the case of a recoverable fault, the process proceeds to step S111 to wait for a command from the user for resuming the printing process after the fault is resolved by user treatment, then resumes the printing process in step S112, and returns to step S102. Even in the case of a recoverable fault, if there is a command for stopping the printing process with no command for resuming the printing process in step S113, the process proceeds to step S114 where the print stoppage event is recorded, and then the printing process routine ends.

When the printing process for the current job ends in step S102, the print end event (event ID=9999) is recorded in step S115, and then the printing process routine ends.

If there is a command from the user for stopping the printing process in step S103 while the printing process is being performed, the print stoppage event is recorded in step S116, the number of printed pages is recorded in step S117, and then the printing process routine ends.

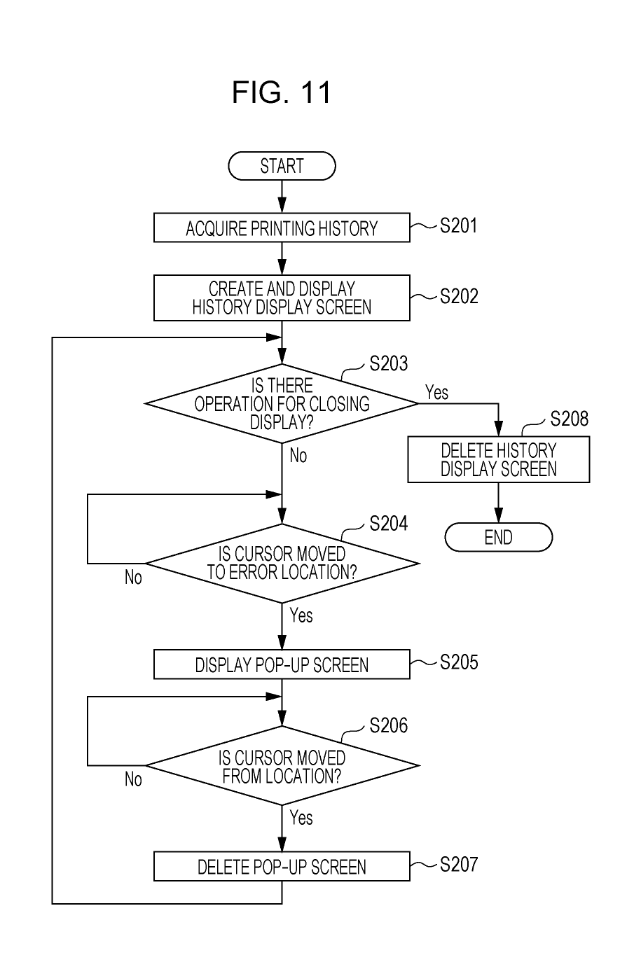

FIG. 11 illustrates a flowchart of a history display process routine.

The history display process routine shown in FIG. 11 is executed when the user inputs a command for displaying the history via the display-input device 230 (see FIG. 1).

First, in step S201, the printing history stored in the storage device 240 (see FIG. 1) is acquired. In step S202, the history display screen as shown in FIG. 6 is created and is displayed on the display screen of the display-input device 230 (see FIG. 1). Then, the following process is executed until there is an input by the user for closing the history display screen in step 203.

In this case, the position of a cursor (e.g., a mouse cursor) on the display screen of the display-input device 230 is monitored, and it is determined in step S204 whether or not the cursor is moved to an error display location (e.g., between the time t4 and the time t5 in the timeline 120 in FIG. 6). Then, when the cursor is moved to the error display location, a pop-up screen indicating detailed information of the error corresponding to the error display location (e.g., the pop-up screen 122 shown in FIG. 7) is displayed in step S205. When the cursor is moved from the error display location in the timeline in step S206, the pop-up screen is deleted in step S207. Then, when there is an operation input by the user for closing the screen in step S203, the history display screen as shown in FIG. 6 is deleted in step S208.

Although the above description relates to an example in which the client PCs 100 and the image output apparatus 200 shown in FIG. 1 are connected via the network 300, the exemplary embodiment of the present invention may alternatively be applied to a system of another type. For example, the exemplary embodiment of the present invention may be applied to a system in which a single PC and a single printer are directly connected to each other and in which the PC functions as the server 210, the display-input device 230, and the storage device 240 shown in FIG. 1. In this case, the combination of the PC and the printer corresponds to an example of an image output apparatus according to an exemplary embodiment of the present invention, and the PC corresponds to an example of a history display apparatus according to an exemplary embodiment of the present invention as well as an example of an information processing apparatus according to an exemplary embodiment of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image output apparatus comprising:
an image printer that prints an image based on image data in accordance with adjunct data for each job including a set of the image data expressing one set of images and the adjunct data necessary for image printing based on the image data;
a history memory that records and stores printing history of printing performed for each job in the image printer, the printing history including recording of whether or not any one of a plurality of predetermined types of errors has occurred and the type of error when an error as occurred; and
a history display that displays the history stored in the history memory such that an icon corresponding to an error that has occurred in a job is displayed in correspondence with the job in which the error has occurred, the icon being one of icons respectively corresponding to groups obtained by classifying the plurality of predetermined types of errors into a plurality of groups.

2. The image output apparatus according to claim 1,
wherein the history display displays the history stored in the history memory such that the icon corresponding to the error that has occurred in the job is displayed in correspondence with the job in which the error has occurred, the icon being one of the icons respectively corresponding to the plurality of classified groups including information indicating whether the plurality of predetermined types of errors are warnings as errors not involving stoppage of a printing process or are faults as errors involving stoppage of the printing process.

3. The image output apparatus according to claim 1,
wherein the history display displays the history stored in the history memory such that the icon corresponding to the error that has occurred in the job is displayed in correspondence with the job in which the error has occurred, the icon being one of the icons respectively corresponding to the plurality of classified groups including information indicating whether the error is a fault involving stoppage of a printing process and recoverable by user treatment or a fault involving stoppage of the printing process and unrecoverable by user treatment.

4. The image output apparatus according to claim 1,
wherein the history memory stores image data expressing an image of a page corresponding to an error occurrence page in the job in which the error has occurred, and
wherein, with regard to the job in which the error has occurred, the history display displays an image, which is based on the image data expressing the image of the page corresponding to the error occurrence page, in correspondence with the job.

5. The image output apparatus according to claim 1,
wherein the history memory stores a print start time, an error occurrence time, an error resolved time, and a print end time for each job, and
wherein the history display displays a time indicator image indicating the print start time, the error occurrence time, the error resolved time, and the print end time for each job.

6. The image output apparatus according to claim 1,
wherein the history display performs indicator display and detailed display for each job stored in the history memory, the indicator display including displaying an indicator that specifies the job and an indicator that indicates whether an error has occurred in the job, the detailed display including displaying details of the error that has occurred in the job stored in the history memory.

7. A history display apparatus comprising:
a history memory that records and stores printing history of printing performed for each job in an image output apparatus that prints an image based on image data in accordance with adjunct data for each job including a set of the image data expressing one set of images and the adjunct data necessary for image printing based on the image data, the printing history including recording of whether or not any one of a plurality of predetermined types of errors has occurred and the type of error when an error has occurred; and
a history display that displays the history stored in the history memory such that an icon corresponding to an error that has occurred in a job is displayed in correspondence with the job in which the error has occurred, the icon being one of icons respectively corresponding to groups obtained by classifying the plurality of predetermined types of errors into a plurality of groups.

8. A non-transitory computer readable medium storing a program causing an information processing apparatus to execute a history display process, the process comprising:
recording and storing printing history of printing performed for each job in an image output apparatus that prints an image based on image data in accordance with adjunct data for each job including a set of the image data expressing one set of images and the adjunct data necessary for image printing based on the image data, the printing history including recording of whether or not any one of a plurality of predetermined types of errors has occurred and the type of error when an error occurred; and
displaying the stored history such that an icon corresponding to an error that has occurred in a job is displayed in correspondence with the job in which the error has occurred, the icon being one of icons respectively corresponding to groups obtained by classifying the plurality of predetermined types of errors into a plurality of groups.

9. A history display method comprising:
recording and storing printing history of printing performed for each job in an image output apparatus that prints an image based on image data in accordance with adjunct data for each job including a set of the image data expressing one set of images and the adjunct data necessary for image printing based on the image data, the printing history including recording of whether or not any one of a plurality of predetermined types of errors has occurred and the type of error when an error has occurred; and
displaying the stored history such that an icon corresponding to an error that has occurred in a job is displayed in correspondence with the job in which the error has occurred, the icon being one of icons respectively corresponding to groups obtained by classifying the plurality of predetermined types of errors into a plurality of groups.
